(19) United States
(12) Patent Application Publication
(10) Pub. No.: US 2026/0258259 A1
(43) Pub. Date: Sep. 3, 2026

(54) POST-CURE TREATMENT OF A FOULING CONTROL COAT

(71) Applicant: Hempel A/S, Kongens Lyngby (DK)

(72) Inventors: Albert CAMÓS NOGUER, Kongens Lyngby (DK); Andreu MORAL CURCÓ, Kongens Lyngby (DK); René SØNDERBÆK-JØRGENSEN, Kongens Lyngby (DK); Regina BÖHM, Kongens Lyngby (DK)

(73) Assignee: Hempel A/S, Kongens Lyngby (DK)

(21) Appl. No.: 19/491,239

(22) PCT Filed: Jun. 7, 2024
(86) PCT No.: PCT/EP2024/065755

§ 371 Date: Dec. 8, 2025

(30) Foreign Application Priority Data
Jun. 9, 2023 (EP) 23382573.6

(51) Int. Cl. C09D 5/16; B05D 1/28; B05D 3/10; B05D 5/00; B05D 7/00; C09D 5/02; C09D 7/44; C09D 7/48; C09D 183/12

(52) U.S. Cl. CPC C09D 5/1637; B05D 1/28; B05D 3/107; B05D 5/00; B05D 7/544; C09D 5/022; C09D 5/1675; C09D 7/44; C09D 7/48; C09D 183/12; B05D 2201/02; B05D 2401/20; B05D 2518/12

(57) ABSTRACT

The present invention relates to a method of post-cure treatment of a fouling control coat, said method comprising the following steps: a. applying an emulsified composition on the surface of said fouling control paint coat; b. allowing the emulsified composition to stay in contact with the surface of said fouling control paint coat for a period of at least 2 hours; wherein said emulsified composition comprises a liquid continuous phase comprising water and a liquid dispersed phase comprising one or more poly(oxyalkylene)-modified silicone oils. The invention further relates to the use of a post-cure treatment for providing fouling control properties to a fouling control paint coat. The invention further relates to a structure, preferably a marine structure, having on the outer surface a fouling control top coat being subjected to a post-cure treatment.

### FIELD OF THE INVENTION

The present invention relates to a method of post-cure treatment of a fouling control coat. The invention further relates to the use of a post-cure treatment for providing fouling control properties to a fouling control paint coat. The invention further relates to a structure, preferably a marine structure, having on the outer surface a fouling control top coat being subjected to a post-cure treatment.

### BACKGROUND OF THE INVENTION

Aquatic structures, in particular immersed marine structures that come in contact with water, especially sea-water, have a tendency to become fouled by marine organisms. Fouling control coatings are abundantly used for such structures, e.g. ships, buoys, watercraft structures, etc. in order to suppress settlement of such marine organisms, or to encourage their release.

Fouling control coating systems for steel structures such as marine structures typically include three principal layers, namely an anticorrosive layer applied to the steel substrate, a fouling control layer, and an intermediate layer, often referred to as a “tie-coat”, for establishing strong bonding between the anticorrosive layer and the fouling control layer. The fouling control layer is often made up of a polysiloxane-based binder matrix.

Polysiloxane-based coatings are widely used in fouling control coatings for marine structures. A known principle for improving the fouling control effect of a polysiloxane based coat is by inclusion of hydrophilic-modified oils and most often also active ingredients such as biocides or enzymes. For example WO 2011/076856 discloses a fouling control coating composition comprising a polysiloxane-based binder system, biocides and hydrophilic-modified silicone oils; WO 2016/004961 discloses a fouling control coating composition comprising a polysiloxane-based binder system, biocides and alcohols modified with poly(oxyalkylene).

These disclosures all describe pre-cure addition of hydrophilic-modified oils to the coating composition, such as poly(oxyalkylene)-modified oils including silicone oils, long-chained alcohols and acrylate oils, i.e. the hydrophilic modified oil has been included in the (wet) coating composition before application on the surface of a substrate.

The fouling defence properties of the coatings described above depend on the presence of these oils in the coating. The concentration of oil has been observed to decrease over time because of different mechanisms such as degradation, diffusion, leaching, etc. (Camós et al., Progress in Organic Coatings (2017), 112: 101-108). The loss of the hydrophilic oil can lead to fouling and generally it is desired to renew the coating system before it has become completely exhausted from the hydrophilic-modified oil. The traditional way to renew the antifouling performance is by applying an entirely new coating layer or system. Application of a full fouling control coating system, or even only the fouling control layer, is time consuming and costly, and requires large amounts of coating material.

Addition of a hydrophobic silicone oil post-curing has recently been disclosed by Kolle et al. (Scientific Reports, Nature (2022) 12:11799: On the mechanism of marine fouling-prevention performance of oil-containing silicone elastomers). According to this post-cure method, the coated object and thus the ship hull has to be immersed completely in a (hydrophobic) silicone oil to achieve incorporation of the oil into the coat which is a cumbersome method and requires a large amount of silicone oil. Further, the polysiloxane based coat takes up the silicone oil in an amount of 45-50 wt % of the polydimethylsiloxane coat, causing the coat to swell up to 50% (from 100 μm to 150 μm). This could have a detrimental effect for the mechanical properties of the film or long-term properties.

Other documents in this technical field include WO2019/233985 and CN114 761 496.

A simple and cheap method for extending and/or improving the fouling control properties of a fouling control coat would be beneficial.

### SUMMARY OF THE INVENTION

The present invention provides a method for post-cure treatment of a fouling control paint coat, said method comprising the following steps:
a. applying an emulsified composition on the surface of said fouling control paint coat;
b. allowing the emulsified composition to stay in contact with the surface of said fouling control paint coat for a period of at least 2 hours;

wherein said emulsified composition comprises a liquid continuous phase comprising water and a liquid dispersed phase comprising one or more poly(oxyalkylene)-modified silicone oils.

In one aspect, the invention relates to the use of a method according to the invention for improving the fouling control properties of a fouling control paint coat.

In one aspect, the invention relates to a fouling control paint coat, preferably a non-erodible paint coat that has been treated by the method according to invention.

Further details of the invention are set out in the dependent claims and the following description.

### DETAILED DESCRIPTION OF THE INVENTION

The present invention relates to a method for post-cure treatment of a fouling control paint coat. The terms “fouling control paint coat” and “fouling control coat” are used interchangeably and refer to a coat obtained from a coating composition, which provides a fouling release surface, where sea organisms cannot stick or are released from the coat when water moves along the surface. The fouling control paint coat is preferably a non-erodible paint coat, more preferably a polysiloxane-based paint coat.

The inventors have found a simple and effective post-cure treatment for a fouling control paint coat that can enhance and/or prolong the fouling control properties of the coat. Unexpectedly, the inventors found that a poly(oxyalkylene)-modified silicone oil (which is hydrophilic or amphiphilic) can be incorporated into a (hydrophobic) fouling control coat by simply applying an emulsified composition onto the surface of said fouling control coat.

In one aspect, the invention therefore simply relates to a method for incorporation of one or more poly(oxyalkylene)-modified silicone oil into a polysiloxane-based paint coat.

In the context of the invention, the term “emulsified composition” refers to a multi-phase system comprising at least a liquid continuous phase and a liquid dispersed phase. In the context of the present invention, said continuous phase comprises water and said dispersed phase comprises one or more poly(oxyalkylene)-modified silicone oil.

Accordingly, the method comprises the steps of
a. applying an emulsified composition on the surface of said fouling control paint coat; and
b. allowing the emulsified composition to stay in contact with the surface of said fouling control paint coat for a period of at least 2 hours;

wherein said emulsified composition comprises a liquid continuous phase comprising water and a liquid dispersed phase comprising one or more poly(oxyalkylene)-modified silicone oil.

In one embodiment, the total amount of water constitutes between 40-99% by weight of said emulsified composition; and the total amount of poly(oxyalkylene)-modified silicone oil constitutes between 1-40% by weight of said emulsified composition.

In one embodiment, the total amount of water constitutes between 40-99 or 40-95, 40-90, 40-85, or 40-80 or 40-75 or 40-70% by weight of said emulsified composition, such as between 45-99 or 45-95 or 45-90 or 45-85, or 45-80 or 45-75 or 45-70%, such as between 50-99 or 50-95 or 50-90 or 50-85, or 50-80 or 50-75 or 50-70% such as between 55-99 or 55-95 or 55-90 or 55-85, or 55-80 or 55-75 or 55-70%, such as between 60-99 or 60-95 or 60-90 or 60-85, or 60-80 or 60-75 or 60-70%, such as between 63-99 or 63-95 or 63-92%, such as between 65-99 or 65-95 or 65-90 or 65-85, or 65-80 or 65-75 or 65-70%, such as between 70-99 or 70-95 or 70-90 or 70-85, or 70-80 or 70-75%, such as between 75-99 or 70-95 or 70-90 or 70-85 or 70-80%, such as between 80-99 or 80-95 or 80-90 or 80-85% by weight of said emulsified composition. In a preferred embodiment, the total amount of water constitutes between 50-90%, more preferably between 50-80%, such as between 50-70% by weight of said emulsified composition.

In one embodiment, the total amount of poly(oxyalkylene)-modified silicone oil constitutes between 1-40 or 1-35 or 1-30 or 1-25% by weight, such as between 2-40, or 2-35 or 2-30 or 2-25% by weight, such as between 5-40, or 1-35 or 5-30 or 5-25% by weight, such as between 10-40 or 10-35 or 10-30 or 10-25% by weight, such as between 15-40 or 15-35 or 15-30 or 15-25% by weight of said emulsified composition. In a preferred embodiment, the total amount of poly(oxyalkylene)-modified silicone oil constitutes between 5-30%, more preferably between 10-30%, such as between 15-25% by weight of said emulsified composition.

Unexpectedly, the inventors discovered that poly(oxyalkylene)-modified silicone oils can be effectively incorporated into a fouling-release coat simply by application of said emulsified composition onto the surface of the coat. The emulsified composition may be applied directly on the surface of the fouling control coat for example by brush or by spray or roller application. The composition may be applied on vertical surfaces such as on the side of a ship hull. It is known from method disclosed by Kolle et al. in Scientific Reports, Nature (2022) 12:11799; that hydrophobic silicone oil can be incorporated into a fouling control coat by immersing the entire coated object (i.e. the ship hull) into the oil for a period. Contrary to the method of the present invention, the method suggested by Kolle et al. is very cumbersome and requires an extensive amount of oil.

The post-cure treatment of the present invention can be used to prolong the fouling control properties of an aged fouling control coat. This method implies many benefits. For example, replacement of a coat or even simply overcoating a vessel with a fresh fouling control coating normally requires the vessel to stay in dry dock for a longer period. The dry dock time can beneficially be considerably reduced by simply replenishing the poly(oxyalkylene)-modified silicone oil into the aged or worn-out fouling control coat by the method of the invention. The terms “aged coat” and “worn-out coat” refers to a coat that has been applied and used for its purpose for at least a period of time, such as at least 6 months, such as at least one year, such as at least two years etc. For an aged fouling control coat, it implies that the coat has been immersed into water for at least that period. In one embodiment, the aged coat is a fouling control paint coat originally prepared from a fouling control coating composition comprising hydrophilic-modified oils in the wet stage. The post-cure treatment of the present invention is then performed after the hydrophilic modified oils has been partly or fully release from the coat. I.e. the treatment serves as replenishing the coat with hydrophilic modified oil.

The method of the invention may also be used to enhance the fouling control properties of a freshly applied coat prepared from a coating composition not already containing any poly(oxyalkylene)-modified silicone oil. I.e. the poly(oxyalkylene)-modified silicone oil is simply incorporated post-curing instead of being included in the coating composition. The term “freshly applied coat” refers to a coat that has not been used for its purpose yet. In one embodiment, the emulsified composition is applied onto the surface of a coat no later than 3 months after application of the coat, such as no later than 2 months from application such as no later than 4 weeks, 3 weeks, 2 weeks or only one week from application of the coat. In a further embodiment, the freshly applied coat has not been immersed into water. The freshly applied coat has been allowed to cure before application of the emulsified composition. I.e, the term “freshly applied coat” refers to a coat that has been allowed to cure before application of the emulsified composition. In one embodiment, the freshly applied coat has been allowed to cure for at least 3 hours, such as at least 4 hours, such as at least 5 hours, preferably at least 6 hours, such as at least 8 hours, such as at least 10 hours, such as at least 12 or 16 or 20 or 24 hours before application of the emulsified composition.

As a further advantage, the emulsified composition of the present invention may be prepared and transported in a concentration that allows the composition to be further diluted with water on-site before application, which enables a reduction of the amount of material to be transported. Furthermore, the emulsified composition may be prepared without the presence of any volatile organic compounds (VOC) which provides a safe and environmentally friendly alternative to overcoating or replacement of a fouling control coat.

The emulsified composition may optionally further comprise one or more light stabilizers and/or radical scavengers, such as hindered amine light stabilizers (HALS), and/or one or more UV-absorbers. Although not preferred, the emulsified composition may also comprise one or more biocides.

The emulsified composition may also comprise additives further described below.

The emulsified composition is applied on the surface of a fouling control paint coat. Said fouling control paint coat is preferably a non-erodible paint coat, more preferably a polysiloxane based paint coat prepared from a coating composition comprising a polysiloxane-based binder system. The polysiloxane-based binder system preferably comprises more than 50 wt % of polysiloxanes, such as more than 55 wt %, such as more than 60 wt % or more than 65 wt %, preferably more than 70 wt % such as more than 75 wt % or 80 wt % or 85 wt % or 90 wt % or 95 wt % of polysiloxanes based on the weight of the total binder system. Fouling control coatings comprising a polysiloxane-based binder system are well-known to the skilled person and has been described in for example WO 2011/079856, WO 2013/000477 and WO 2014/117786.

The emulsified composition is prepared from a primary composition and a secondary composition. The primary composition comprises the liquid carrier for the continuous phase, which comprises water, and the secondary composition comprises the one or more poly(oxyalkylene)-modified silicone oil. The liquid carrier may optionally, in addition to water, include one or more further liquids with suitable properties. The primary and the secondary composition may comprise further constituents such as hindered amine light stabilizers, UV-absorbers and additives as later described.

In the context of the invention, when reference is made to the “emulsified composition” it refers to the mixed composition ready to be applied on the fouling control coat.

### Poly(Oxyalkylene)-Modified Silicone Oil

According to the invention, the emulsified composition comprises a disperse phase comprising one or more poly(oxyalkylene)-modified silicone oils.

Poly(oxyalkylene)-modified silicone oils are widely used as surfactants and emulsifiers due to the content of both hydrophilic and lipophilic groups in the same molecule. “Poly(oxyalkylene)-modified silicone oil” usually refers to a silicone oil of hydrophobic nature, which has been modified with poly(oxyalkylene) moieties for example as internal side chains and/or terminally. Poly(oxyalkylene) refers to repeating units of oxygen and alkylene, typically ethylene and propylene.

Of particular interest are those poly(oxyalkylene)-modified silicone oils in which the relative weight of the poly(oxyalkylene) chains is 1% or more of the total weight (e.g. 1-90%), such as 5% or more (e.g. 5-80%), in particular 10% or more (e.g. 10-70%) of the total weight of the poly(oxyalkylene)-modified silicone oil. In one embodiment the relative weight of the poly(oxyalkylene) chains is in the range of 25-60%, such as 30-50%, of the total weight of the poly(oxyalkylene)-modified silicone oil. In another embodiment the relative weight of the poly(oxyalkylene) chains is in the range of 15-50% such as 20-40% by weight.

When calculating the amount of the poly(oxyalkylene) parts for a given poly(oxyalkylene)-modified silicone oil, it is typically fairly straightforward to distinguish it from the silicone part. However, in order to eliminate any doubt about any linkers between the two, it should be understood that the poly(oxyalkylene) parts include all atoms up to, but not including, the silicon atom which is adjacent to the poly(oxyalkylene) parts. As an example, in a structure such as of Formula (I) below, the residue of formula (i) accounts for the poly(oxyalkylene) part (the hydrophilic part).

In a preferred embodiment, the poly(oxyalkylene)-modified silicone oil has a number average molecular weight (Mn) in the range of 100-100,000 g/mol, such as in the range of 250-75,000 g/mol, in particular in the range of 500-50,000 g/mol, or 500-30,000 g/mol.

In another preferred embodiment, the poly(oxyalkylene)-modified silicone oil has a number average molecular weight (Mn) in the range of 500-20,000 g/mol, such as 1,000-10,000 g/mol, or 1,000-7,500 g/mol, or even 1,500-5,000 g/mol.

In a preferred embodiment, the poly(oxyalkylene)-modified silicone oil has the structure according to formula (I) below:

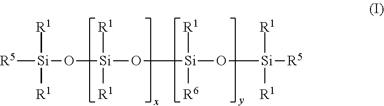

wherein,
each R¹ is independently selected from C₁-C₅-alkyl (including linear or branched hydrocarbon groups) and aryl (e.g. phenyl (—C₆H₅)), preferably methyl;
each R⁵ and R⁶ are independently selected from R¹, and the residue according to formula (i) below

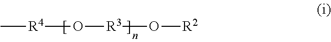

each R² is independently selected from —H, C₁-C₄-alkyl (e.g. —CH₃, —CH₂CH₃, —CH₂CH₂CH₃, —CH(CH₃)₂, —CH₂CH₂CH₂CH₃), phenyl (—C₆H₅), and C₁-C₄-alkylcarbonyl (e.g. —C(═O)CH₃, —C(═O)CH₂CH₃ and —C(═O)CH₂CH₂CH₃), in particular —H, methyl and —C(═O)CH₃;
each R³ is independently selected from C₂-C₅ alkylene (e.g —CH₂CH₂—, —CH₂CH(CH₃), —CH₂CH₂CH₂—, —CH₂CH₂CH₂CH₂—, —CH₂CH(CH₂CH₃)—), arylene (e.g. 1,4-phenylene) and C₂-C₅-alkylene substituted with aryl (e.g. 1-phenyl ethylene), in particular from C₂-C₅-alkylene such as —CH₂CH₂— and —CH₂CH(CH₃)—;
each R⁴ is selected from —(CH₂)₂₋₆—;
x is an integer of 0-2500 and y is an integer of 0-100, with the proviso that x+y is 1 or larger;
and n is 1-70;
with the proviso that at least R⁶ or one of R⁵ is a residue according to formula (i).

In particular, three variations exists within the structure of formula (I). These are polysiloxanes having grafted thereto poly(oxyalkylene) chains; polysiloxanes having incorporated in the backbone thereof poly(oxyalkylene) chains; and combinations of those two variations.

### Grafted Chains:

In one embodiment, said poly(oxyalkylene)-modified silicone oil constitutes a polysiloxane having grafted thereto poly(oxyalkylene) chains.

An illustrative example of the structure of such poly(oxyalkylene)-modified silicone oils is the compound of formula (I) wherein:
both of R⁵ are R1;
R⁶ is a residue according to formula (i);
x is an integer of 0-2500 and y is an integer of 1-100; and
R¹, R², R³, R⁴ and n are as defined above.

### Chains Incorporated in Backbone

In one embodiment, said poly(oxyalkylene)-modified silicone oil constitutes a polysiloxane having incorporated in the backbone thereof poly(oxyalkylene) chains.

An illustrative example of the structure of such poly(oxyalkylene)-modified silicone oils is the compound of formula (I) wherein:
at least one of R⁵ is a residue according to formula (i);
X is an integer of 1-2500 and y is 0; and
R¹, R², R³, R⁴ are as defined above.

In a particular embodiment, both of R⁵ is a residue according to formula (i).

### Combined Incorporated and Grafted Chains

In one embodiment, said poly(oxyalkylene)-modified silicone oil constitutes a polysiloxane having incorporated in the backbone thereof poly(oxyalkylene) chains, and at the same time having grafted poly(oxyalkylene) chains to the backbone.

An illustrative example of the structure of such poly(oxyalkylene)-modified silicone oils is the compound of formula (I) wherein:
R⁶ and at least one of R⁵ constitute a residue according to formula (i);
X is an integer of 1-2500 and y is an integer of 1-100; and
R¹, R², R³, R⁴ and n are as defined above.

In a particular embodiment, R⁶ and both of R⁵ constitute a residue according to formula (i). It should be understood that the one or more non-reactive poly(oxylalkylene)-modified silicone oils, may be of different types, e.g. two or more of the types described above.

In formula (I) including the three variations described above, the groups —CH₂CH(CH₃)—, —CH₂CH(CH₂CH₃)—, etc. may be present in any of the two possible orientations. Similarly, it should be understood that the segments present x and y times typically are randomly distributed, or distributed as blocks, within the polysiloxane structure.

In these embodiments and variants, the poly(oxyalkylene) is preferably selected from polyoxyethylene, polyoxypropylene and poly(oxyethylene-co-oxypropylene), which sometimes are referred to as poly(ethylene glycol), poly(propylene glycol) and poly(ethylene glycol-co-propylene glycol). Hence, in the above formula (I) each R³ linking two oxygen atoms is preferably selected from —CH₂CH₂— and —CH₂CH(CH₃)—, whereas each R⁴ linking a silicon atom and an oxygen atom preferably is selected from C₂-C₅-alkyl.

Preferably, the non-reactive poly(oxylalkylene)-modified silicone oils are devoid of aromatic substituents.

The following embodiments relates to the compound of formula (I) as such, and the three variations described above.

In a preferred embodiment, n is 3-60, such as 3-50, such as 3-40, such as 4-20. In a further embodiment, n is 6-40, such as 6-30 or 6-25 or 6-20.

In a preferred embodiment, x is 3-1000, such as 3-500, such as 3-200, such as 3-150, such as 3-100, such as 3-50, such as 3-30, such as 3-20, such as 3-15 or 4-12. In a further embodiment, x is 6-200, such as 6-100, such as 6-50, such as 6-20. In a further embodiment, x is 10-200, such as 10-100, such as 10-50, such as 10-20. In another further embodiment, x is 20-200, such as 20-100, such as 20-50.

In a preferred embodiment, n+x is 3-1000, such as 3-500, such as 3-200, such as 3-150, such as 3-100, such as 3-50. In a further embodiment, n+x is 6-100, such as 6-50, such as 6-40 or 6-30.

In a preferred embodiment, x+y is 3-1000, such as 3-500, such as 3-200, such as 3-150, such as 3-100, such as 3-50, such as 3-30, such as 8-30, or x+y is 3-15, such as 4-12, or x+y is 6-20, such as 8-15.

Interesting commercially available non-reactive poly(oxyalkylene)-modified silicone oils are, DOWSIL 2-8692 from DOW, OFX-5103, OFX-190, OFX 5211, OFX-5220, OFX-5247, OFX-5329, OFX-5330, OFX-3667, and OFX-193 (all from Xiameter), BYK-331, BYK-378, BYK-Silclean 3701, BYK-Silclean 3710, BYK-3760, BYK-377 (all from BYK), DBE-621, CMS-222 from Gelest, CoatOSil 3501, Silwet 7280, CoatOSil 7210, CoatOSil 7200, CoatOSil 7602, CoatOSil 1220 (all from Momentive), TEGO Glide 410 and TEGO Glide 435 from Evonik industries, Borchi Gol LA200 (from Borchers) and KF352A, KF353, KF945, KF6012, KF-6015, KF6017, KF-6020, KF-6701 from Shin-Etsu. In the context of the invention, the poly(oxyalkylene)-modified silicone oil preferably has an HLB (hydrophilic-lipophilic balance) in the range of 1.5-14, such as 1.5-14, preferably 1.5-12, more preferably 1.5-10, such as 1.5-8 or 2-10, herein typically determined according to Griffin's model using the equation “wt-% hydrophilic groups”/5 (Reference: Griffin, W. C. Calculation of HLB values of non-ionic surfactants, J. Soc. Cosmet. Chem. 1954, 5, 249-256). The HLB parameter is a well-established characterisation method for non-ionic surfactants.

Poly(oxyalkylene)-modified silicone oils have further been described in for example WO 2011/076856 and WO 2014/117786.

Typically, the total amount of poly(oxyalkylene)-modified silicone oil constitutes between 1-40 or 1-35 or 1-30 or 1-25% by weight, such as between 2-40, or 2-35 or 2-30 or 2-25% by weight, such as between 5-40, or 1-35 or 5-30 or 5-25% by weight, such as between 10-40 or 10-35 or 10-30 or 10-25% by weight, such as between 15-40 or 15-35 or 15-30 or 15-25% by weight of said emulsified composition. Preferably, the total amount of poly(oxyalkylene)-modified silicone oil constitutes between 5-30%, more preferably between 10-30%, such as between 15-25% by weight of said emulsified composition.

### Further Components

The emulsified composition may comprise further components, which when present will typically have been included in the primary composition or the secondary composition before mixing.

Said further components may be selected from the non-limiting list of hindered amine light stabilizers, UV absorbers and additives as further described below.

### Hindered Amine Light Stabilizers (HALS)

In one embodiment, the emulsified composition further comprises one or more hindered amine light stabilizer (HALS), comprising sterically hindered amine moieties which may for example be selected from 2,2,6,6-tetraalkyl piperidine derivatives. It has been demonstrated that such sterically hindered amine moieties when used in combination with constituents comprising poly(oxyalkylene) chains improves the fouling control performance of a polysiloxane-based fouling control paint coat (WO 2019/233985).

It appears that the existence of the sterically hindered amine moiety (e.g. a 2,2,6,6-tetraalkyl piperidine motif) plays an important role for the functionality of the hindered amine light stabilizer. Otherwise, it is envisaged that a broad range of derivatives are applicable, including those present as discrete molecules and those being part of oligomeric or polymeric structures.

In one embodiment, the hindered amine light stabilizer(s) comprise hindered amine moieties of general formula I:

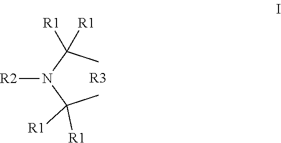

wherein
each R1 is independently selected from C₁-C₄ alkyl, preferably methyl;
R2 is selected from the list consisting of optionally substituted C₁-C₃₀-alkyl, optionally substituted C₂-C₃₀-alkenyl, optionally substituted aryl, optionally substituted C₁-C₃₀-alkoxy, optionally substituted C₁-C₃₀-alkenyloxy, optionally substituted aryloxy, optionally substituted C₁-C₃₀-alkylcarbonyl, optionally substituted C₁-C₃₀-alkenylcarbonyl, and optionally substituted arylcarbonyl, —H and —OH (corresponding to N—O·);
R3 is an optionally substituted divalent group forming an N-heterocyclic 5-, 6- or 7-membered ring together with the intervening —C(R1)₂-N(R2)-C(R1)₂- group; and wherein the R2 and/or R3 with the before-mentioned meanings may be linked to 1-200, such as 1-150, such as 1-100, preferably 1-50, such as 1-40 or 1-30 or 1-20 or 1-10 hindered amine moieties each independently having the general Formula I.

In some embodiments, R2 is selected from optionally substituted C₁-C₃₀-alkyl, optionally substituted C₁-C₃₀-alkenyl, optionally substituted aryl, optionally substituted C₁-C₈-alkoxy, optionally substituted C₁-C₈-alkenyloxy, optionally substituted aryloxy, optionally substituted C₁-C₈-alkylcarbonyl, optionally substituted C₁-C₈-alkenylcarbonyl, and optionally substituted arylcarbonyl.

In one embodiment, R2 is selected from C₁-C₄-alkyl, C₁-C₄-alkoxy and C₁-C₄-alkylcarbonyl.

In some embodiments, R3 is selected from —CH₂—C(~)—CH₂— (corresponding to piperidine) and —CH₂—N(~)—CH₂— (corresponding to piperazine), in particular —CH₂—C(~)—CH₂—, where designates hydrogen atom(s) and/or the attachment point(s) for a substituent, a linker, a scaffold, a dendrimer, or a polymer, or the like.

In certain embodiments, R3 is selected from —CH₂—C(R₄)—CH₂— (corresponding to piperidine) and —CH₂—N(R4)-CH₂- (corresponding to piperazine), in particular —CH₂—C(R4)-CH₂—, where R4 is as defined (generally and specifically) below for general formula II.

In some embodiments, the hindered amine light stabilizers are discrete molecules including only one hindered amine moiety, in particular a piperidine moiety of general formula II (below).

In other embodiments, the hindered amine light stabilizers are oligomers including, e.g. 2-200, hindered amine moieties, in particular piperidine moieties of general formula II (below). In variants hereof, the moieties are linked together.

In a preferred embodiment, the hindered amine light stabilizer(s) are selected from 2,2,6,6-tetraalkyl piperidine derivatives, i.e. the hindered amine moieties are 2,2,6,6-tetraalkyl piperidine moieties of general formula II:

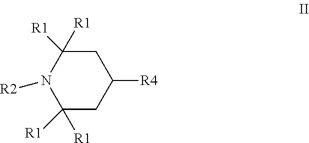

wherein R1 and R2 are defined as above; and R4 represents hydrogen atom(s) and/or the attachment point(s) for a polymer.

In some embodiments, R4 represents zero (where the 4-position of the piperidine is unsubstituted).

In some embodiments, R4 represent one or two substituents selected from C₁-C₃₀-alkyl, C₁-C₃₀-alkenyl, aryl, hydroxy, C₁-C₃₀-alkoxy, C₁-C₃₀-alkenyloxy, aryloxy, C₁-C₃₀-alkylcarbonyl, C₁-C₃₀-alkenylcarbonyl, arylcarbonyl, C₁-C₃₀-alkylcarbonyloxy, C₁-C₃₀-alkenylcarbonyloxy, and arylcarbonyloxy; and wherein the substituent R4 with the before-mentioned meanings may be linked to 1-200 hindered amine moieties each independently having the General Formula II.

In some embodiments, R4 represent one or two substituents selected from C₁-C₈-alkoxy, C₁-C₈-alkenyloxy, aryloxy, C₁-C₈-alkylcarbonyloxy, C₁-C₈-alkenylcarbonyloxy, and arylcarbonyloxy.

In other embodiments, R4 represents two substituents forming a spiro structure, e.g. a spiro structure of a heterocyclyl nature.

Variants of hindered amine light stabilizers, such as 2,2,6,6-tetraalkyl piperidine derivatives, are very abundant in the literature and from commercial sources. Preferred are the following types: N—C₁-C₃₀-alkyl piperidine derivatives, N—C₁-C₃₀-alkenyl piperidine derivatives, N-aryl piperidine derivatives, N—C₁-C₃n-alkoxy piperidine derivatives, N—C₁-C₃₀-alkenyloxy piperidine derivatives, N-aryloxy piperidine derivatives, N—C₁-C₃₀-alkylcarbonyl piperidine derivatives, N—C₁-C₃₀-alkenylcarbonyl piperidine derivatives, and N-arylcarbonyl piperidine derivatives.

In some embodiments the following types are more preferred: N—C₁-C₃₀-alkyl piperidine derivatives, N—C₁-C₃₀-alkenyl piperidine derivatives, and N-aryl piperidine derivatives, in particular N—C₁-C₃₀-alkyl piperidine derivatives.

In other embodiments the following types are more preferred: N—C₁-C₃₀-alkoxy piperidine derivatives, N—C₁-C₃₀-alkenyloxy piperidine derivatives, and N-aryloxy piperidine derivatives, in particular N—C₁-C₃₀-alkoxy piperidine derivatives.

In still other embodiments the following types are more preferred: N—C₁-C₃₀-alkylcarbonyl piperidine derivatives, N—C₁-C₃₀-alkenylcarbonyl piperidine derivatives, and N-arylcarbonyl piperidine derivatives, in particular N—C₁-C₃₀-alkylcarbonyl piperidine derivatives.

Without being bound to any particular theory, it is envisaged that the pKa values of the 2,2,6,6-tetraalkyl piperidine derivatives preferably should be below 8.5. Hence, it is preferred that the N is substituted (i.e. not N—H). More preferably, the pKa is below 8.0, such as below 7.0, e.g. below 6.0 or even below 5.0.

Furthermore, it is preferred that the 2,2,6,6-tetraalkyl piperidine derivatives (as well as generally the sterically hindered amines) in the overall structure of formula I or II do not include any primary amines or secondary amines. Furthermore, the structures of formula I or II should preferably not include any non-hindered tertiary amines.

In the present context, any alkylene and alkenylene moieties include both linear and branched moieties. For example, C₁-C₃₀-alkyl includes linear and branched C₁-C₃₀ alkyl. When any R group (in particular R1, R2, R3 and R4) are described as being “optionally substituted”, this means that that may be substituted at any suitable position with halogen (—F, —Cl, —Br or —I), —C₁-C₄ alkyl, or —OH. The term “spiro” has its regular meaning in organic chemistry; i.e. two or more rings which share a common atom.

The hindered amine light stabilizer moieties, such as the derivates of formula I or II, may be present in the emulsified composition as discrete molecules and/or as part of an oligomeric or polymeric structure. In one embodiment, the sterically hindered amine moieties, such as the derivates of formula I or II, are present in the emulsified composition as discrete molecules. In another embodiment, the sterically hindered amine moieties are present in the emulsified composition as part of an oligomeric or polymeric structure.

Examples of hindered amine light stabilizers, such as in particular 2,2,6,6-tetraalkyl piperidine derivatives are further described in WO 2019/233985 and WO 2016/105974, which are incorporated herein by reference.

Illustrative examples of commercial hindered amine light stabilizers of the 2,2,6,6-tetramethyl piperidine type are: Sabostab UV 65 (N—CH3), Sabostab UV 40 (N—H), Sabostab UV 79 (N—H) from Sabo S.p.A.; Hostavin 3058 (N-Acyl), Hostavin 3070 (Oligomeric) and Hostavin 3050 from Clariant; Tinuvin 622 (Oligomeric), Tinuvin 144 (N—CH3), Flamestab NOR 116 (N—O—R), Chimassorb 944 (N—H), Tinuvin 249 (N—O—R), Tinuvin 440 (N-Acyl), Tinuvin 152 (N—O—R), Tinuvin 123 (N—O—R), Uvinul 4050 H (N—H), Lignostab 1198 (N—O·, monomer), Uvinul 5050 H (N—H, polymeric) from BASF; ADK STAB LA-52 (N—CH3), ADK STAB LA-68 (N—H), ADK STAB LA-82 (N—CH3) from Adeka Palmarole; and UBS-0822 (N—H, siloxane), UBS-0541 (N—H, siloxane) from Gelest. Preferably Tinuvin 123 (N—O—R), Hostavin 3050 and Tinuvin 292 If hindered amine light stabilizer(s) are present in the emulsified composition, they will typically be present in a total amount of up to 10% by weight of the emulsified composition, such up to 5%, 4% 3% or 2% or 1% by weight of the emulsified composition, preferably 0.01-10% by weight of the emulsified composition, such as in an amount of 0.1-5%, such as 0.1-4% or 0.1-3% or 0.1-2% or 0.1-1% by weight of the emulsified composition, or in an amount of 0.01-4%, such as 0.01-3% or 0.01-2% or 0.01-1% by weight of the emulsified composition.

Any hindered amine light stabilizer(s) included in the composition are typically included in the secondary composition before mixing the primary and the secondary composition.

### UV-Absorbers

The emulsified composition may further comprise one or more UV absorbers. UV absorbers are light stabilizers that function by absorbing damaging UV radiation, protecting the polymer from degradation by UV-light, due to their high UV absorbing capability and dissipate the absorbed UV energy as heat without altering the properties of the polymer. This mechanism is complementary to the free radical scavenging mechanism of hindered amine light stabilizers, and as a result UV-absorbers may be used alone or in combination with hindered amine light stabilizers to achieve higher performance.

However, in one embodiment, the UV-absorber is present without the concurrent presence of a hindered amine light stabilizer, as described above.

Examples of UV-absorbers are benzotriazoles, benzoates, benzophenones, cyanoacrylates, oxanilides or triazines.

Preferred UV-absorbers are benzotriazoles, or triazines.

Interesting commercially available UV-absorbers are Tinuvin 99-2, Tinuvin 326, Tinuvin 900, Tinuvin 1130, ADK STAB LA-29, ADK STAB LA-46 and ADK STAB 1413.

If present, the total amount of UV-absorber typically constitutes up to 10% by weight of the emulsified composition, such up to 5%, 4% 3% or 2% or 1% by weight of the emulsified composition, preferably 0.01-10% by weight of the emulsified composition, such as in an amount of 0.1-5%, such as 0.1-4% or 0.1-3% or 0.1-2% or 0.1-1% by weight of the emulsified composition, or in an amount of 0.01-4%, such as 0.01-3% or 0.01-2% or 0.01-1% by weight of the emulsified composition.

Any UV absorber(s) included in the composition are typically included in the secondary composition before mixing the primary and the secondary composition.

### Biocides

The claimed post-cure treatment provides an efficient anti-fouling effect without including biocides in the emulsified composition. Thus, in a preferred embodiment, the emulsified composition does not contain any biocides for the purpose of providing antifouling effect. Although inclusion of biocides is not preferred, the emulsified composition may comprise biocides. Biocides relevant for fouling-control systems are well known by the skilled person and may for example be selected from the biocides listed in WO 2023/036923.

### Additives

The emulsified composition and/or the primary composition may comprise additives such as rheological modifiers (including thixotropic agents, thickening agents and anti-settling agents), dispersing agents, wetting agents, surfactants, binders, plasticizers and dyes. Examples of rheological modifiers are colloidal silica, hydrated aluminium silicate (bentonite), aluminium tristearate, aluminium monostearate, xanthan gum, chrysotile, pyrogenic silica, hydrogenated castor oil, hydroxy ethyl cellulose, organo-modified clays, polyamide waxes and polyethylene waxes. Additives are typically included in the primary composition before mixing the primary and the secondary composition. The rheological modifiers are typically present in the emulsified composition in an amount of 0-10% by weight, more preferably 0.1-5.0% by weight, even more preferably 0.1-2.0% by weight. Since the claimed compositions are water based, antifungal components known to the skilled person may be included as a further additive for improving shelf life.

### Preparation of the Emulsified Composition

The emulsified composition is prepared from a primary composition and a secondary composition. The primary composition comprises the liquid carrier for the continuous phase, which is typically water, and the secondary composition comprises the one or more poly(oxyalkylene)-modified silicone oil. The primary and the secondary composition may comprise further constituents such as hindered amine light stabilizers, UV-absorbers and additives as later described.

The emulsified composition can be prepared by first preparing a primary composition comprising water and optional additives as described above, and separately preparing a secondary composition comprising poly(oxyalkylene)-modified silicone oil and optionally hindered amine light stabilizers and UV absorbers as described above, and subsequently mixing the primary and secondary compositions. One particular method for preparation of the emulsified composition is described below.

All components for the primary composition may be mixed in a highspeed dissolver equipped with an impeller disc at 3500 rpm for at least 15 min. The components for the secondary composition may be mixed by hand for at least 2 min. The primary composition and the secondary composition may then be mixed together in a highspeed dissolver equipped with an impeller disc at 3500 rpm for at least 15 min, shortly before application. Similar methods and variations of the method described herein may be utilised by the person skilled in the art.

It should be understood that when reference is made to the “emulsified composition”, it refers to the mixed composition comprising the constituents contained in the continuous phase and the dispersed phase in the desired amounts ready to be applied on the fouling control coat.

### Application of the Emulsified Composition

The emulsified composition according to the invention is applied on top of a fouling control coat, preferably a polysiloxane based coat.

The term “applying” is used in its normal meaning within the paint industry. Thus, “applying” is conducted by means of any conventional means, e.g. by brush, by roller, by spraying, etc. The most commercially interesting way of “applying” the emulsified composition is by roller or by spraying. Hence, the emulsified composition is preferably sprayable. Spraying is effected by means of conventional spraying equipment known to the person skilled in the art. The emulsified composition is typically applied in a wet film thickness of 30-400 μm, such as 50-400 μm, e.g. 75-300 μm, or 75-200, such as about 100 μm.

Typically the emulsified composition is applied in an amount of 0.03 to 0.4 litre per square meter, such as 0.05 to 0.4 litre per square meter, e.g. 0.075 to 0.3 litre pr square meter.

After having been in contact with the surface for at least 2 hours, the remaining emulsified composition that is left on the surface may be removed either by direct removal or by dissolution when sailing. Said composition is typically removed with water e.g. by flushing the surface with water or by washing with a brush or a sponge or by air-blowing. The water may optionally contain soap which is optionally subsequently removed by washing with water. Another way of removing the excess composition is by polishing e.g by polishing with a cloth. In one embodiment, excess composition is left on the surface without removal.

The term “at least a part of the surface of a substrate” refers to the fact that the emulsified composition may be applied to any fraction of the surface. The emulsified composition is applied to at least a part of the substrate (e.g. a fouling control coat) where the surface may come in contact with water, e.g. sea-water.

The term “substrate” in the present context is intended to mean the top coat of a fouling control coating. The substrate typically comprises a polysiloxane-based coat. Alternative substrates such as other non-erodible coatings may also be relevant, such as acrylate coatings.

The term “surface” is used in its normal sense, and refers to the exterior boundary of an object. In the context of the invention, the emulsified composition is applied on the surface of a fouling control paint coat. The fouling control paint coat, whereto the emulsified composition is applied, is typically present on the surface of a marine structure, such as vessels (including but not limited to boats, yachts, motorboats, motor launches, ocean liners, tugboats, tankers, container ships and other cargo ships, submarines, and naval vessels of all types). In one embodiment, the fouling control paint coat is present on pipes, shore and off-shore machinery, constructions such as piers, pilings, bridge substructures, water-power installations and structures, underwater oil well structures etc.

In one embodiment, the emulsified composition is applied onto a freshly applied fouling control paint coat as previously described. In one embodiment, the emulsified composition is applied on an aged coat, e.g. a worn out fouling control paint coat.

### Numbered Embodiments

In the following, embodiments of the invention are disclosed. It should be understood that the various aspects, embodiments, implementations and features of the invention mentioned herein may be claimed separately, or in any combination.
E1. A method for post-cure treatment of a fouling control paint coat, said method comprising the following steps:
a. applying an emulsified composition on the surface of said fouling control paint coat;
b. allowing the emulsified composition to stay in contact with the surface of said fouling control paint coat for a period of at least 2 hours;
wherein said emulsified composition comprises a liquid continuous phase comprising water and a liquid dispersed phase comprising one or more poly(oxyalkylene)-modified silicone oils.
E2. The method according to embodiment E1, wherein the total amount of water constitutes between 40-99 or 40-95, 40-90, 40-85, or 40-80 or 40-75 or 40-70% by weight of said emulsified composition, such as between 45-99 or 45-95 or 45-90 or 45-85, or 45-80 or 45-75 or 45-70%, such as between 50-99 or 50-95 or 50-90 or 50-85, or 50-80 or 50-75 or 50-70% such as between 55-99 or 55-95 or 55-90 or 55-85, or 55-80 or 55-75 or 55-70%, such as between 60-99 or 60-95 or 60-90 or 60-85, or 60-80 or 60-75 or 60-70%, such as between 63-99 or 63-95 or 63-92%, such as between 65-99 or 65-95 or 65-90 or 65-85, or 65-80 or 65-75 or 65-70%, such as between 70-99 or 70-95 or 70-90 or 70-85, or 70-80 or 70-75%, such as between 75-99 or 70-95 or 70-90 or 70-85 or 70-80%, such as between 80-99 or 80-95 or 80-90 or 80-85 by weight of said emulsified composition.
E3. The method according to any of embodiments E1-E2, wherein the total amount of poly(oxyalkylene)-modified silicone oil constitutes between 1-40 or 1-35 or 1-30 or 1-25% by weight, such as between 2-40, or 2-35 or 2-30 or 2-25% by weight, such as between 5-40, or 1-35 or 5-30 or 5-25% by weight, such as between 10-40 or 10-35 or 10-30 or 10-25% by weight, such as between 15-40 or 15-35 or 15-30 or 15-25% by weight of said emulsified composition.
E4. The method according to any of embodiments E1-E3, wherein the total amount of water constitutes between 40-99 or 40-95, 40-90, 40-85, or 40-80 or 40-75 or 40-70% by weight of said emulsified composition, such as between 45-99 or 45-95 or 45-90 or 45-85, or 45-80 or 45-75 or 45-70%, such as between 50-99 or 50-95 or 50-90 or 50-85, or 50-80 or 50-75 or 50-70% such as between 55-99 or 55-95 or 55-90 or 55-85, or 55-80 or 55-75 or 55-70%, such as between 60-99 or 60-95 or 60-90 or 60-85, or 60-80 or 60-75 or 60-70%, such as between 63-99 or 63-95 or 63-92%, such as between 65-99 or 65-95 or 65-90 or 65-85, or 65-80 or 65-75 or 65-70%, such as between 70-99 or 70-95 or 70-90 or 70-85, or 70-80 or 70-75%, such as between 75-99 or 70-95 or 70-90 or 70-85 or 70-80%, such as between 80-99 or 80-95 or 80-90 or 80-85 by weight of said emulsified composition; and
the total amount of poly(oxyalkylene)-modified silicone oil constitutes between 1-40 or 1-35 or 1-30 or 1-25% by weight, such as between 2-40, or 2-35 or 2-30 or 2-25% by weight, such as between 5-40, or 1-35 or 5-30 or 5-25% by weight, such as between 10-40 or 10-35 or 10-30 or 10-25% by weight, such as between 15-40 or 15-35 or 15-30 or 15-25% by weight of said emulsified composition.
E5. The method according to any of embodiments E1-E4, wherein said emulsified composition is allowed to stay in contact with the surface of said fouling control paint coat for a period of at least 3 hours, preferably at least 4 or 5 hours, more preferably at least 6, 7, 8, 9 or 10 hours, such as at least 11, 12, 13, 14, 15, 16, 17, 18, 19, 20, 21, 22, 23 or 24 hours.
E6. The method according to any of any of any of embodiments E1-E5, wherein said emulsified composition is allowed to stay in contact with the surface of said fouling control paint coat for a period between 4-48 hours, such as between 4-40 hours, 4-36 hours, 4-32 hours, 4-28 hours or 4-24 hours, or between 6-48 hours, such as between 6-40 hours, 6-36 hours, 6-32 hours, 6-28 hours or 6-24 hours.
E7. The method according to any of any of embodiments E1-E6, wherein said emulsified composition is prepared from a primary composition comprising water and a secondary composition comprising poly(oxyalkylene)-modified silicone oil.
E8. The method according to embodiment E7, wherein said primary composition comprises at least 70% by weight, such as at least 80% by weight, such as at least 90% by weight, preferably at least 95% by weight, such as at least 99 wt % of water; and said secondary composition comprises least 1% by weight, such as at least 5% by weight, such as at least 10% by weight, such as at least 15% by weight, such as at least 20% by weight of poly(oxyalkylene)-modified silicone oil.
E9. The method according to any embodiments E1-E8, wherein said method further comprises the following step:
c. removing excess emulsified composition from the surface of said fouling control paint coat after step b,
wherein said removal is performed by flushing the surface with water or by washing with a brush or a sponge;
E10. The method according to embodiment E9, wherein said removal is further performed by washing the surface with soap and subsequently rinsing with water.
E11. The method according to any of embodiments E1-E10, wherein said poly(oxyalkylene)-modified silicone oil is characterised by having an HLB value in the range of 1.5-14, such as 1.5-14, preferably 1.5-12, more preferably 1.5-10, such as 1.5-8 or 2-10
E12. The method according to any of embodiments E1-E11, wherein the poly(oxyalkylene) moiety of said poly(oxyalkylene)-modified silicone oil is selected from polyoxyethylene; polyoxypropylene and/or poly(oxyethylene-co-oxypropylene), preferably polyoxyethylene.
E13. The method according to any of embodiments E1-E12, wherein said emulsified composition is applied at a wet film thickness of 30-400 μm, such as 50-400 μm, e.g. 75-300 μm, or 75-200, such as about 100 μm.
E14. The method according to any of embodiments E1-E13, wherein said emulsified composition and/or said secondary composition further comprises
   i) one or more hindered amine light stabilizers; and/or
   ii) one or more UV-absorbers.
E15. The method according to embodiment E14, wherein said one or more hindered amine light stabilizer is selected from 2,2,6,6-tetraalkyl piperidine derivatives.
E16. The method according to any of embodiments E14-E15, wherein said one or more hindered amine light stabilizer is present in an amount of up to 10% by weight of the emulsified composition, such up to 5%, 4% 3% or 2% or 1% by weight of the emulsified composition.
E17. The method according to any of embodiments E14-E16, wherein said one or more hindered amine light stabilizer is present in an amount of 0.01-10% by weight of the emulsified composition, such as in an amount of 0.1-5%, such as 0.1-4% or 0.1-3% or 0.1-2% or 0.1-1% by weight of the emulsified composition, or in an amount of 0.01-4%, such as 0.01-3% or 0.01-2% or 0.01-1% by weight of the emulsified composition.
E18. The method according to any of embodiments E14-E17, wherein said one or more UV-absorber is selected from the list consisting of benzotriazoles, benzoates, benzophenones and triazines.
E19. The method according to any of embodiments E14-E18, wherein said one or more UV absorber is present in an amount of up to 10% by weight of the emulsified composition, such as up to 5%, up to 4% up to 3% or up to 2% or up to 1% by weight of the emulsified composition.
E20. The method according to any of embodiments E14-E19, wherein said one or more UV absorber is present in an amount of 0.01-5% by weight of the emulsified composition, such as in an amount of 0.1-5%, such as 0.1-4% or 0.1-3% or 0.1-2% or 0.1-1% by weight of the emulsified composition, or in an amount of 0.01-4%, such as 0.01-3% or 0.01-2% or 0.01-1% by weight of the emulsified composition.
E21. The method according to any of embodiments E1-E21, wherein said emulsified composition and/or said primary composition further comprises one or more additives such as one or more rheological modifiers, such as thixotropic agents, thickening agents and/or anti-settling agents.
E22. The method according to embodiment E21, wherein said rheological modifiers are selected from colloidal silica, hydrated aluminium silicate (bentonite), aluminium tristearate, aluminium monostearate, xanthan gum, chrysotile, pyrogenic silica, hydrogenated castor oil, hydroxy ethyl cellulose, organo-modified clays, polyamide waxes and polyethylene waxes.
E23. The method according to any of embodiments E21-E22, wherein said rheological modifiers are present in an amount of 0-10% by weight, more preferably 0.1-5.0% by weight, even more preferably 0.1-2.0% by weight.
E24. The method according to any of embodiments E1-E23, wherein said emulsified composition is applied by brush or roller or spray application, preferably by spray application.
E25. The method according to any of embodiments E1-E24, wherein said fouling control 30 paint coat has been applied onto the outer surface of a substrate, wherein said substrate is a substrate for immersion in water such as a native vessel.
E26. The method according to any of embodiments E1-E25, comprising the initial step of identifying a substrate comprising on the outer surface said fouling control paint coat.
E27. The method according to any of embodiments E1-E26, wherein said fouling control paint coat is a non-erodible paint coat, preferably a polysiloxane based paint coat.
E28. The method according to any of embodiments E1-E27, wherein said fouling control paint coat is a freshly applied coat.
E29. The method according to any of embodiments E1-E28, wherein said fouling control paint coat is an aged coat, such as a worn-out coat.
E30. The method according to any of embodiments E1-E29, wherein said fouling control paint coat constitutes the outermost layer of an fouling control system further comprising a primer and/or a tie coat.
E31. The method according to any of embodiments E1-E30, wherein said emulsified composition consists or consists essentially of:
   a liquid continuous phase comprising water,
   a liquid dispersed phase comprising one or more poly(oxyalkylene)-modified silicone oils,
   optionally, one or more hindered amine light stabilizers, preferably being a 2,2,6,6-tetraalkyl piperidine derivative,
   optionally, one or more UV-absorbers, and
   one or more, preferably two or more, rheological modifiers.
E32. The method according to any of embodiments E1-E31, wherein said emulsified composition comprises or consists of:
   at least 60% by weight of said emulsified composition of a liquid continuous phase comprising water,
   1-25% by weight of said emulsified composition of one or more poly(oxyalkylene)-modified silicone oils,
   1-10% by weight of said emulsified composition of one or more hindered amine light stabilizers, preferably being a 2,2,6,6-tetraalkyl piperidine derivative,
   0.1-10% by combined weight of said emulsified composition of two or more rheological modifiers.
E33. Use of a method according to any of embodiments E1-E32 for improving the fouling control properties of a fouling control paint coat.
E34. A fouling control paint coat, preferably a non-erodible paint coat such as a polysiloxane-based paint coat that has been treated by the method according to any of embodiments E1-E32
E35. The fouling control paint coat according to embodiment E32 having on at least a part of the outer surface a multilayer system comprising
i) one or more layers of a cured primer;
ii) one or more layers of cured tie coat, and
iii) one or more further layers of cured fouling control coat;
wherein said fouling control coat has been treated by the method according to any of embodiments E1-E32.

All references, including publications, patent applications, and patents, cited herein are hereby incorporated by reference in their entirety and to the same extent as if each reference were independently and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context. For example, the phrase “the composition” is to be understood as referring to various “compositions” of the invention or particular described aspect, unless otherwise indicated.

The description herein of any aspect or aspect of the invention using terms such as “comprising”, “having,” “including” or “containing” with reference to an element or elements is intended to provide support for a similar aspect or aspect of the invention that “consists of”, “consists essentially of” or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

The use of any and all examples, or exemplary language (including “for instance”, “for example”, “e.g.”, and “such as”) in the present specification is intended merely to better illuminate the invention, and does not pose a limitation on the scope of invention unless otherwise indicated.

Headings and sub-headings are used herein for convenience only, and should not be construed as limiting the invention in any way. The use of any and all examples, or exemplary language (including “for instance”, “for example”, “e.g.”, and “such as”) in the present specification is intended merely to better illuminate the invention, and does not pose a limitation on the scope of invention unless otherwise indicated. The citation and incorporation of patent documents herein is done for convenience only, and does not reflect any view of the validity, patentability and/or enforceability of such patent documents.

It should be understood that the various aspects, embodiments, implementations and features of the invention mentioned herein may be claimed separately, or in any combination.

### EXPERIMENTAL

The invention will be illustrated by the following non-limiting examples.

### Testing for Antifouling Performance

Acrylic panels of 150 mm×200 mm were used for static immersion testing. The emulsified composition was applied on top of a polysiloxane-based coat using, airless spray, Dr Blade applicator, brush or roller. After the specified time, the emulsion was removed using tap-water and a sponge for approximately 1 minute. Soap was used to remove residues of the emulsified composition. Further water rinsing was used to remove any soap residues.

In cases where the polysiloxane-based coat was freshly applied, the coat has been applied onto a suitable tie-coat according to the specifications of the polysiloxane-based coat, and then allowed to cure for at least 6 hours ensuring that the coat was touch dry before application of the emulsified composition. The polysiloxane-based coats were applied in dry film thicknesses of about 66-200 μm. In most examples the dft was 200 μm.

Antifouling performance was tested on panels at Vilanova i la Geltrú, located in north-eastern Spain. At this test site the panels were immersed into sea water with salinity in the range of 37-38 parts per thousand at an average temperature of 17-18° C.

Panels were inspected every 4-12 weeks and evaluated according to the following scale:

| Level | Description |
|---|---|
| Excellent | Only slime |
| Good | Algae + Animals < 10% |
| Fair | 10% < Algae + Animals < 25% |
| Poor | Algae + Animals > 25% |

### Extraction and Quantification of Poly(Oxyalkylene)-Modified Silicone Oil Using GPC.

Samples of the silicone substrate coatings were cut using a scalpel and added to a 0.5-1 ml of tetrahydrofuran (THF) containing a polystyrene internal standard (C=0.554 μmol/L and Mw=130 kg/mol). The samples were extracted for 2 hours on a shaker and then decanted into a 1 ml Vial.

The content of poly(oxyalkylene)-modified silicone oil absorbed by the poly(siloxane)-based coating was quantified using Gel Permeation Chromatography (GPC). The GPC system consists of three columns, 2× PLgel 5 (m Mixed D (300×7.5 mm) and a PLgel 5 μm Mixed C.° (300×7.5 mm). GPC curves were recorded using an ELS detector and a eluent mixture of tetrahydrofuran and 5% triethyl amine at a flow rate of 1 mL/min. In order to quantify the amount of poly(oxyalkylene)-modified silicone oil that was extracted from the coating, a calibration curve was prepared where poly(oxyalkylene)-modified silicone oil was added to the liquid poly(siloxane)-based coating mixture prior to application. One calibration curve was prepared (using BYK-3764 as a poly(oxyalkylene)-modified silicone oil) and used to calibrate across all poly(oxyalkylene)-modified silicone oils.

### Materials

TABLE 1
List of materials used for the polysiloxane-based
coating compositions and emulsified compositions.

| Name | Function | Supplier |
|---|---|---|
| OH Polymer 3900 | Binder | Wacker Chemie (DE) |
| Wacker Polymer C2T | Binder | Wacker Chemie (DE) |
| TIB KAT 218 | Catalyst | TIB Chemicals (DE) |
| Bayferrox 130 M | Red pigment | Lanxess (DE) |
| HDK H 15 | Rheological modifier | Wacker Chemie (DE) |
| Crayvallac Super | Rheological modifier | Arkema (FR) |
| WACKER TES 40 WN | Silicate binder | Wacker Chemie (DE) |
| OS 2600 | Silicate binder | Nitrochemie Aschau GmbH (DE) |
| Xylene | Solvent | Technical grade |
| Acetyl Acetone | Stabilizing agent | Wacker Chemie (DE) |
| Tinuvin 123 | HALS | BASF Corporation (DE) |
| Tinuvin 99-2 | UV absorber | BASF Corporation (DE) |
| PEG-PDMS oil A | Proprietary poly(oxylakylene)- | |
| | modified silicone (HLB = 6.2) | |
| PEG-PDMS oil B | Proprietary poly(oxylakylene)- | |
| | modified silicone (HLB = 1.8) | |
| PEG-PDMS oil C | Proprietary poly(oxyalkylene)- | |
| | modified silicone oil (HLB = 4) | |
| PEG-PDMS oil D | Proprietary poly(oxyalkylene)- | |
| | modified silicone oil (HLB = 4) | |
| BYK-3764 | Poly(oxyalkylene)-modified silicone | BYK Chemie (DE) |
| | oil | |
| X-24-1430 | Poly(oxyalkylene)-modified silicone | Shin-Etsu Chemicals (JP) |
| | oil | |
| LA200 | Poly(oxyalkylene)-modified silicone | Borchers |
| | oil | |
| Silsurf Di-1010-AC | Poly(oxyalkylene)-modified silicone | Siltech Corp. (CA) |
| | oil | |
| BYK-LP X 22065 | Poly(oxyalkylene)-modified silicone | BYK Chemie (DE) |
| | oil | |
| KF-353 | Poly(oxyalkylene)-modified silicone | ShinEtsu (JP) |
| | oil (HLB = 10) | |
| KF-643 | Poly(oxyalkylene)-modified silicone | ShinEtsu (JP) |
| | oil (HLB = 14) | |
| Garamite 1958 | Rheological modifier | BYK Chemie (US) |
| Natrosol 250 GR | Rheological modifier | Ashland Inc (US) |
| Axilat RH23 | Rheological modifier | Synthomer PLC (UK) |

TABLE 2
Polysiloxane based coating composition (abbreviated SC).

| | | | SC |
|---|---|---|---|
| | Function | Material | Wt % |
| Part I | Binder | OH polymer 3900 | 68.4 |
| | Binder | Wacker Polymer C2T | |
| | Rheological modifier | HDK H 15 | 1.1 |
| | Rheological modifier | Crayvallac Super | 0.8 |
| | Pigment | Bayferrox 130 M | 4.5 |
| | Solvent | Xylene | 16.9 |
| Part II | Binder | Wacker TES 40 WN | 2.6 |
| | Binder | OS 2600 | |
| | Catalyst | TIB KAT 218 | 0.5 |
| | Stabilizer | Acetyl acetone | 1.1 |
| | Solvent | Xylene | 4.1 |

The polysiloxane coating (SC) was prepared by mixing all components of Part I in a pearl mill at 75° C. for 30 minutes and then filtrate by colander. The components of Part 11 were mixed by hand for 2 minutes.

### Antifouling Performance

The compositions presented below were prepared according to the prescriptions provided in this document. The emulsified compositions were then applied to a freshly applied coating layer using a Dr Blade applicator with a gap-size of 300 μm. After 96 hours the Emulsified compositions were removed from the substrates by gently washing by sponge with hot water and detergent for approximately one minute. Residual soap was removed by hot water. Afterwards substrates were left to dry vertically at room temperature. The treated panels were tested for antifouling performance according to the prescription provided above.

TABLE 3A
Various concentrations of poly(oxyalkylene) modified silicone oil. Amounts are
indicated by weight % based on the total weight of the emulsified composition.

| | | | 3A.1 | 3A.2 | 3A.3 | 3A.4 | 3A.5 | 3A.6 |
|---|---|---|---|---|---|---|---|---|
| Composition | | | (wt-%) | (wt-%) | (wt-%) | (wt-%) | (wt-%) | (ref) |
| Primary | Rheological | Natrosol | 3.5 | 3.9 | 4.1 | 4.3 | 4.4 | — |
| composition | modifier | 250 GR | | | | | | |
| | | Garamite | 3.8 | 4.3 | 4.6 | 4.8 | 4.8 | — |
| | | 1958 | | | | | | |
| | Carrier | Water | 72.7 | 81.8 | 86.3 | 89.9 | 90.8 | — |
| Secondary | Poly(oxyalkylene)- | BYK 3764 | 20.0 | 10.0 | 5.0 | 1.0 | — | — |
| composition | modified silicone | | | | | | | |
| | oil | | | | | | | |

| | | | | | | |
|---|---|---|---|---|---|---|
| Substrate # | SC | SC | SC | SC | SC | SC |
| DFT (μm) | 200 | 200 | 200 | 200 | 200 | 200 |
| Time before removal of emulsified | 96 | 96 | 96 | 96 | 96 | — |
| composition (hours) | | | | | | |
| RAFT performance after 12 weeks | Excellent | Excellent | Excellent | Fair | Poor | Poor |
| Extracted poly(oxyalkylene)-modified | 1.96 | 1.48 | 1.06 | N/A | — | — |
| silicone oil quantified using GPC (wt %) | | | | | | |

N/A means the extracted amount is below the detection level.

Table 3A shows that the post treatment of a silicone coating with the emulsified composition containing hydrophilic modified oil in various concentrations significantly improves the antifouling performance compared to a non-treated counterpart. Furthermore, it can be seen that the amount of poly(oxyalkylene)-modified silicone oil that can be extracted after treatment with the emulsified composition is comparable to adding up to 2 wt % of poly(oxyalkylene)-modified silicone oil to a liquid poly(siloxane)-based mixture prior to application of the coating. Example 3A.4 was below the detection limit of the extraction and quantification method.

TABLE 3B
Various concentrations of poly(oxyalkylene) modified silicone oil. Amounts are
indicated by weight % based on the total weight of the emulsified composition.

| | | | 3B.1 | 3B.2 | 3B.3 | 3B.4 | 3B.5 |
|---|---|---|---|---|---|---|---|
| Composition | | | (wt-%) | (wt-%) | (wt-%) | (wt-%) | (ref) |
| Primary | Rheological | Natrosol 250 GR | 3.4 | 3.6 | 4.3 | 3.8 | — |
| composition | modifier | Garamite 1958 | 3.7 | 3.9 | 4.8 | 4.1 | — |
| | | Axilat RH23 | 0.28 | 0.29 | — | 0.3 | — |
| | carrier | Water | 82.6 | 87.2 | 90.0 | 91.8 | — |
| Secondary | Poly(oxyalkylene) | PEG-PDMS oil D | 10.0 | 5.0 | 1.0 | — | — |
| composition | modified | | | | | | |
| | silicone oil | | | | | | |

| | | | | | |
|---|---|---|---|---|---|
| Substrate # | SC | SC | SC | SC | SC |
| DFT (μm) | 200 | 200 | 200 | 200 | 200 |
| Time before removal of emulsified composition | 24 | 24 | 24 | 24 | — |
| (hours) | | | | | |
| RAFT performance after 29 weeks | Excellent | Excellent | Excellent | Poor | Poor |

Table 3B shows that the post treatment of a silicone coating with the emulsified composition containing hydrophilic modified oil in various concentrations significantly improves the antifouling performance compared to both an emulsified composition without a hydrophilic modified oil and a non-treated counterpart.

TABLE 4
Time before removal of emulsified composition. Amounts are indicated by weight % based on the total weight of the emulsified composition.

| | | | 4.1 | 4.2 | 4.3 | 4.4 | 4.5 | 4.6 | 4.7 | 4.8 | 4.9 |
|---|---|---|---|---|---|---|---|---|---|---|---|
| Composition | | | (wt-%) | (wt-%) | (wt-%) | (wt-%) | (wt-%) | (wt-%) | (wt-%) | (wt-%) | (ref) |
| Primary | Rheological | Natrosol | 3.1 | 3.1 | 3.1 | 3.1 | 3.1 | 3.1 | 3.1 | 3.1 | — |
| composition | modifier | 250 GR | | | | | | | | | |
| | | Garamite | 3.4 | 3.4 | 3.4 | 3.4 | 3.4 | 3.4 | 3.4 | 3.4 | — |
| | | 1958 | | | | | | | | | |
| | carrier | Water | 63.7 | 63.7 | 63.7 | 63.7 | 63.7 | 63.7 | 63.7 | 63.7 | — |
| Secondary | Poly(oxyalkylene) | PEG- | 20.0 | 20.0 | 20.0 | 20.0 | — | — | — | — | — |
| composition | modified silicone | PDMS | | | | | | | | | |
| | oil | oil A | | | | | | | | | |
| | | PEG- | — | — | — | — | 20.0 | 20.0 | 20.0 | 20.0 | — |
| | | PDMS | | | | | | | | | |
| | | oil B | | | | | | | | | |
| | HALS | Tinuvin | 10.0 | 10.0 | 10.0 | 10.0 | 10.0 | 10.0 | 10.0 | 10.0 | — |
| | | 123 (g) | | | | | | | | | |

| | | | | | | | | | |
|---|---|---|---|---|---|---|---|---|---|
| Substrate # | SC | SC | SC | SC | SC | SC | SC | SC | SC |
| DFT (μm) | 200 | 200 | 200 | 200 | 200 | 200 | 200 | 200 | 200 |
| Time before removal of | 2 | 6 | 24 | 96 | 2 | 6 | 24 | 96 | — |
| emulsified composition (hours) | | | | | | | | | |
| Extractable Amount of | 3.84 | 59.01 | 99.53 | 100 | 1.30 | 14.75 | 78.31 | 100 | |
| poly(oxyalkylene)-modified | | | | | | | | | |
| silicone oil quantified using GPC | | | | | | | | | |
| (in percent of 96 hour) | | | | | | | | | |
| RAFT performance after 4 weeks | Good | Excellent | Excellent | Excellent | Poor | Fair | Excellent | Excellent | Poor |
| RAFT performance after 36 weeks | Poor | Excellent | Excellent | Excellent | Poor | Poor | Excellent | Excellent | Poor |

Table 4 shows that the uptake of poly(oxyalkylene)-modified silicone oil increases with exposure time and antifouling performance increases by increased exposure time. Comparative example 4.9 which is non-treated shows poor performance already after 4 weeks.

TABLE 5
Variation of the poly(oxyalkylene)-modified silicone oil. Amounts are indicated
by weight % based on the total weight of the emulsified composition.

| | | | 5.1 | 5.2 | 5.3 | 5.4 | 5.5 | 5.6 |
|---|---|---|---|---|---|---|---|---|
| Composition | | | (wt-%) | (wt-%) | (wt-%) | (wt-%) | (wt-%) | (ref) |
| Primary | Rheological | Natrosol 250 GR | 3.0 | 3.0 | 3.0 | 3.0 | 3.0 | — |
| composition | modifier | Garamite 1958 | 3.3 | 3.3 | 3.3 | 3.3 | 3.3 | — |
| | Carrier | Water | 64.6 | 64.6 | 64.6 | 64.6 | 64.6 | — |
| Secondary | Poly(oxyalkylene)- | X-24-1430 | 19.4 | — | — | — | — | — |
| composition | modified silicone | LA200 | — | 19.4 | — | — | — | — |
| | oil | Silsurf Di 1010- | — | — | 19.4 | — | — | — |
| | | AC | | | | | | |
| | | PEG-PDMS oil C | — | — | — | 19.4 | — | — |
| | | BYK-LP X 22065 | — | — | — | — | 19.4 | — |
| | HALS | Tinuvin 123 | 9.7 | 9.7 | 9.7 | 9.7 | 9.7 | — |

| | | | | | | |
|---|---|---|---|---|---|---|
| Substrate # | SC | SC | SC | SC | SC | SC |
| DFT (μm) | 200 | 200 | 200 | 200 | 200 | 200 |
| Time before removal of emulsified | 96 | 96 | 96 | 96 | 96 | — |
| composition (hours) | | | | | | |
| Raft performance after 20 weeks | Excellent | Excellent | Good | Excellent | Excellent | Poor |
| Raft performance after 36 weeks | Excellent | Good | Poor | Excellent | Excellent | Poor |

Table 5 shows that the raft performance after 20 weeks in sea-water in Spain is “good” or “excellent” for all types of poly(oxyalkylene)-modified silicone oils tested. Comparative example 5.6 shows poor performance both after 20 and 36 weeks.

TABLE 6
Variation of the HLB of the poly(oxyalkylene)-modified silicone oil. Amounts are
indicated by weight % based on the total weight of the emulsified composition.

| | | | 6.1 | 6.2 | 6.3 |
|---|---|---|---|---|---|
| Composition | | | (wt-%) | (wt-%) | (ref) |
| Primary | Rheological | Natrosol 250 GR | 4.0 | 4.0 | — |
| composition | modifier | Garamite 1958 | 4.3 | 4.3 | — |
| | Carrier | Water | 82.0 | 82.0 | — |
| Secondary | Poly(oxyalkylene)- | KF-353 (HLB = 10) | 10 | — | — |
| composition | modified silicone | KF-643 (HLB = 14) | — | 10 | — |
| | oil | | | | |

| | | | |
|---|---|---|---|
| Substrate # | SC | SC | SC |
| DFT (μm) | 200 | 200 | 200 |
| Time before removal of | 24 | 24 | — |
| emulsified composition (hours) | | | |
| Raft performance after 29 weeks | Good | Poor | Poor |

Table 6 shows that the raft performance after 29 weeks in sea-water in Spain is “Good” when the HLB=10, whereas performance drops when HLB increases to 14.

TABLE 7
Various concentrations of poly(oxyalkylene) modified silicone oil and HALS. Amounts
are indicated by weight % based on the total weight of the emulsified composition.

| | | | 7.1 | 7.2 | 7.3 | 7.4 | 7.5 | 7.6 |
|---|---|---|---|---|---|---|---|---|
| Composition | | | (wt-%) | (wt-%) | (wt-%) | (wt-%) | (wt-%) | (ref) |
| Primary | Rheological | Natrosol 250 | 3.1 | 3.3 | 3.3 | 3.7 | 3.9 | — |
| composition | modifier | GR (g) | | | | | | |
| | | Garamite | 3.4 | 3.6 | 3.6 | 4.1 | 4.3 | — |
| | | 1958 | | | | | | |
| | Carrier | Water (g) | 63.6 | 68.1 | 70.8 | 77.2 | 80.9 | — |
| Secondary | Poly(oxyalkylene) | Byk 3764 (g) | 20.0 | 20.0 | 20.0 | 10.0 | 10.0 | — |
| composition | modified silicone | | | | | | | |
| | oil | | | | | | | |
| | HALS | Tinuvin 123 | 10.0 | 5.0 | 1.0 | 5.0 | 1.0 | — |
| | | (g) | | | | | | |

| | | | | | | |
|---|---|---|---|---|---|---|
| Substrate # | SC | SC | SC | SC | SC | SC |
| DFT (μm) | 200 | 200 | 200 | 200 | 200 | 200 |
| Time before removal of emulsified | 96 | 96 | 96 | 96 | 96 | — |
| composition (hours) | | | | | | |
| RAFT performance after (12 weeks) | Excellent | Excellent | Excellent | Excellent | Excellent | Poor |
| Wt. % of oil (quantified by GPC) | 1.24 | 1.71 | 1.70 | 1.31 | 1.50 | — |

Table 7 shows the method using compositions of varying concentrations of poly(oxyalkylene)-modified silicone oil and HALS. The performance of the panels after treatment is seen to be high for varying concentrations.

Examples from Table 3A and 7 were tested for antifouling performance in the same test series. I.e. the blank coat (ref) in Table 3A and 7 is the same.

TABLE 8
Various dry film thicknesses (DFT). Amounts are indicated by weight
% based on the total weight of the emulsified composition.

| | | | 8.1 | 8.2 | 8.3 | 8.4 |
|---|---|---|---|---|---|---|
| Composition | | | (wt-%) | (wt-%) | (wt-%) | (ref) |
| Primary | Rheological modifier | Natrosol 250 GR | 4.1 | 4.09 | 4.09 | |
| composition | | Garamite 1958 | 4.5 | 4.5 | 4.5 | |
| | carrier | Water | 85.4 | 85.4 | 85.4 | |
| Secondary | Poly(oxyalkylene) | Byk 3764 | 5.0 | 5.0 | 5.0 | |
| composition | modified silicone oil | | | | | |
| | HALS | Tinuvin 123 | 1.0 | 1.0 | 1.0 | |

| | | | | |
|---|---|---|---|---|
| Substrate # | SC | SC | SC | SC |
| DFT (μm) | 200 | 130 | 66 | 200 |
| Time before removal of emulsified composition (hours) | 96 | 96 | 96 | — |
| RAFT performance after 12 weeks | Excellent | Excellent | Excellent | Poor |
| Wt. % of oil (quantified by GPC) | 1.27 | 1.33 | 1.09 | — |

Table 8 proves excellent performance for substrates of different thickness. It is also noted that a higher quantity of oil is absorbed with increasing film thickness.

Examples from Table 3A, 7 and 8 were tested for antifouling performance in the same test series. I.e. the blank coat (ref) in Table 3A, 7 and 8 is the same.

TABLE 9
Various concentrations of HALS and UV absorbers in the formulations. Amounts are
indicated by weight % based on the total weight of the emulsified composition.

| | | | 9.1 | 9.2 | 9.3 | 9.4 | 9.5 | 9.6 |
|---|---|---|---|---|---|---|---|---|
| Composition | | | (wt-%) | (wt-%) | (wt-%) | (wt-%) | (wt-%) | (ref) |
| Primary | Rheological | Natrosol 250 GR | 3.4 | 3.2 | 3.2 | 3.2 | 3.0 | |
| composition | modifier | Garamite 1958 | 3.7 | 3.5 | 3.5 | 3.4 | 3.3 | |
| | | Axilat RH23 | 0.3 | 0.3 | 0.3 | 0.3 | 0.2 | |
| | Carrier | Water | 82.6 | 78.0 | 78.0 | 77.1 | 73.5 | |
| Secondary | Poly(oxyalkylene) | X-24-1430 | 10 | 10 | 10 | 10 | 10 | |
| composition | modified silicone | | | | | | | |
| | oil | | | | | | | |
| | HALS | Tinuvin 123 | — | 5 | — | 1 | 5 | |
| | UV absorbers | Tinuvin 99-2 | — | — | 5 | 5 | 5 | |

| | | | | | | |
|---|---|---|---|---|---|---|
| Substrate # | SC | SC | SC | SC | SC | SC |
| DFT (μm) | 200 | 200 | 200 | 200 | 200 | 200 |
| Time before removal of emulsified composition | 24 | 24 | 24 | 24 | 24 | — |
| (hours) | | | | | | |
| RAFT performance after 24 weeks | Excellent | Excellent | Excellent | Excellent | Excellent | Poor |

Table 9 shows the method using compositions of varying concentrations of hindered amine light stabilisers and UV absorbers. The performance of the panels after treatment is seen to be high for varying concentrations.

1.-18. (canceled)

19. A method for post-cure treatment of a fouling control paint coat, said method comprising the following steps:
a. applying an emulsified composition on the surface of said fouling control paint coat;
b. allowing the emulsified composition to stay in contact with the surface of said fouling control paint coat for a period of at least 2 hours;
wherein said emulsified composition comprises a liquid continuous phase comprising water and a liquid dispersed phase comprising one or more poly(oxyalkylene)-modified silicone oils.

20. The method according to claim 19, wherein the total amount of water constitutes between 40-99% by weight of said emulsified composition; and the total amount of poly(oxyalkylene)-modified silicone oil constitutes between 1-40% by weight of said emulsified composition.

21. The method according to claim 19, wherein said emulsified composition is allowed to stay in contact with the surface of said fouling control paint coat for a period of at least 3 hours, preferably at least 4 or 5 hours, more preferably at least 6, 7, 8, 9 or 10 hours, such as at least 11, 12, 13, 14, 15, 16, 17, 18, 19, 20, 21, 22, 23 or 24 hours.

22. The method according to claim 19, wherein said method further comprises the following step:
c. removing excess emulsified composition from the surface of said fouling control paint coat after step b, wherein said removal is performed by flushing the surface with water or by washing with a brush or a sponge.

23. The method according to claim 19, wherein said poly(oxyalkylene)-modified silicone oil is characterised by having an HLB value in the range of 1.5-14, such as 1.5-14, preferably 1.5-12, more preferably 1.5-10, such as 1.5-8 or 2-10

24. The method according to claim 19, wherein said fouling control paint coat is a non-erodible paint coat, preferably a polysiloxane based paint coat.

25. The method according to claim 19, wherein said emulsified composition is applied at a wet film thickness of 30-400 μm, such as 50-400 μm, e.g. 75-300 μm, or 75-200, such as about 100 μm.

26. The method according to claim 19, wherein said emulsified composition is prepared from a primary composition comprising water and a secondary composition comprising poly(oxyalkylene)-modified silicone oil.

27. The method according to claim 19, wherein said emulsified composition and/or said secondary composition further comprises i) one or more hindered amine light stabilizers; and/or ii) one or more UV-absorbers.

28. The method according to claim 27, wherein said one or more hindered amine light stabilizer is present in an amount of 0.01-10% by weight of the emulsified composition, such as in an amount of 0.1-5%, such as 0.1-4% or 0.1-3% or 0.1-2% or 0.1-1% by weight of the emulsified composition, or in an amount of 0.014%, such as 0.01-3% or 0.01-2% or 0.01-1% by weight of the emulsified composition.

29. The method according to claim 19, wherein said fouling control paint coat is a freshly applied coat.

30. The method according to claim 19, wherein said fouling control paint coat is an aged coat, such as a worn-out coat.

31. The method according to claim 19 wherein said emulsified composition and/or said primary composition comprises one or more additives such as one or more rheological modifiers, such as thixotropic agents, thickening agents and/or anti-settling agents.

32. Use of a method according to claim 19 for improving the fouling control properties of a fouling control paint coat.

33. A fouling control paint coat, preferably a non-erodible fouling control paint coat such as a polysiloxane-based paint coat that has been treated by the method according to claim 19.

34. An emulsified composition for post-cure treatment of a fouling control paint coat, preferably a non-erodible fouling control paint coat such as a polysiloxane-based paint coat, the emulsified composition comprising at least a liquid continuous phase and a liquid dispersed phase, wherein the liquid continuous phase comprises water, and the liquid dispersed phase comprises one or more poly(oxyalkylene)-modified silicone oils.

35. The emulsified composition according to claim 34, wherein the total amount of water constitutes between 40-99% by weight of said emulsified composition.

36. The emulsified composition according to claim 34, wherein the total amount of poly(oxyalkylene)-modified silicone oil constitutes between 1-40% by weight of said emulsified composition.

37. The emulsified composition according to claim 34, wherein the composition further comprises one or more hindered amine light stabilizers, preferably being a 2,2,6,6-tetraalkyl piperidine derivative, one or more UV-absorbers, and/or one or more, preferably two or more, rheological modifiers.

38. The emulsified composition according to claim 34, wherein the composition comprises or consists of: at least 60% by weight of said emulsified composition of the liquid continuous phase comprising water, 1-25% by weight of said emulsified composition of the one or more poly(oxyalkylene)-modified silicone oils, 1-10% by weight of said emulsified composition of one or more hindered amine light stabilizers, preferably being a 2,2,6,6-tetraalkyl piperidine derivative, and 0.1-10% by combined weight of said emulsified composition of two or more rheological modifiers.
